(19) United States
(12) Patent Application Publication
(10) Pub. No.: US 2002/0108256 A1
(43) Pub. Date: Aug. 15, 2002

(54) Kitchen utensil

(76) Inventors: Peter Egelund, Solbjerg (DK); Poul Solbjerg, Solbjerg (DK)

Correspondence Address: James C. Wray, Suite 300, 1493 Chain Bridge Road, McLean, VA, 22101, US

(21) Appl. No.: 10/059,180

(22) Filed: Jan. 31, 2002

(30) Foreign Application Priority Data
Jan. 31, 2000 (DK) PA 2001 00155

(51) Int. Cl. A47J 43/28

(52) U.S. Cl. 30/147; 30/148; 30/149; 30/150; 30/322; 30/324

(57) ABSTRACT

A kitchen utensil for handling food products, the handle of which has a cross section which is substantially V-shaped or U-shaped. Kitchen utensils of this kind can easily be stacked to form a compact unit.

### BACKGROUND OF THE INVENTION

The present invention relates to a kitchen utensil with a handle and a tool for handling food products. The present invention also relates to a kitchen utensil kit.

### SUMMARY OF THE INVENTION

Kitchen utensil structures of various types are used according to prior art to accommodate food preparation, for example grilling as in a barbecue scenario. The popularity of barbecues has led to an ever increasing creativity concerning the technology of barbecue tools.

U.S. Pat. No. 4,844,525, discloses a combination barbecue fork and spatula tool which can be inserted under a food item with an upper pivoted pointed or barbed portion that can grasp the food item so it can be picked up and turned over or removed.

U.S. Pat. No. 4,955,971 discloses a combination of a fork and a spatula for barbecue work comprising a pair of parallel arms with barbecue implements at distal ends thereof and which are hingedly joined by a pair of spaced cross members so as to form a movable parallelogram at the other end thereof. This allows the tool to be adjusted in either of two positions so that the arms are adjacent and parallel with the distal end of either arm projecting forward so that its implement can be used alone, or with the arms parallel and spaced apart so that the arms can be squeezed together so that the implements can used as a pair of tongs.

U.S. Pat. No. 5,206,998 discloses a barbecue tool members with telescopingly mounted tools permitting compactness of storage and transport.

As may be judged from the examples above, problems in connection with barbecue tools have been solved in most cases with rather complicated structures, which are difficult to handle and expensive to produce.

It is an object of the invention to provide kitchen utensils, preferably for barbecues, that are easy and safe to handle, easy and cheap to produce, and which permit to be stored as a set of utensils in a compact way.

### DESCRIPTION OF THE INVENTION

These objects are achieved with a kitchen utensil with a handle and a tool for handling food products, wherein the handle has a cross section which is substantially V-shaped or U-shaped.

A kitchen utensil with a handle that has a V-shaped or U-shaped cross section according to the invention has a number of advantages over prior art. The shape of the handle is very easy and cheap to produce, as it can formed by bending a plate-like material, preferably stainless steel, which has been cut from an initial plate. Alternatively the handle may be formed in polymer by heat treatment.

An additional advantage is that the V-shaped or U-shaped handle is very stable against bend of the handle during use, also when used with heavy food products, which is important for proper and safe function. Because the handle is substantially plate like, a number of kitchen utensils of this type can be arranged with their handles in stacking conditions so as to form a compact unity, which is a further advantage.

Furthermore, for kitchen utensils as a tong, a spatula, a fork, and a hook according to the invention, the simple construction of the handle allows the kitchen utensil to be produced as one single piece of plate-like material like stainless steel without any welding or any other type of constructional joint. A method for fabrication is, for example, where a suitable piece of plate-like material is punched out of a larger plate, after which the handle is bent into a V-shaped or U-shaped form.

As indicated above, polymer and stainless steel are preferred materials for the kitchen utensil, because these materials have a low heat conductivity, which is important when used with hot barbecues to prevent injury of the user.

A kitchen utensil according to the invention may be at least partly covered with a coating. In case that the coating shall guarantee a non-slippery grip, the coating may be of rubber-like nature. In case that the front part of the kitchen utensil shall have non sticking capabilities when touching food, the surface of the front part may be covered with a non-sticking coating, for example Teflon. Furthermore, coating may be applied to the kitchen utensil in order to apply different colours to the kitchen utensil.

As is apparent from the mentioned advantages, a kitchen utensil according to the invention solves a large number of problems in a very simple way.

The invention will be described in more detail in the following with reference to the drawings.

### BRIEF DESCRIPTION OF THE DRAWINGS

FIG. 1 shows a spatula member according to the invention.

FIG. 2 shows a cross section of the handle of a kitchen utensil according to the invention.

FIG. 3 shows a fork member according to the invention.

FIG. 4 shows a tong member according to the invention.

FIG. 5 shows a brush according to the invention.

FIG. 6 shows a barbecue kitchen utensil set.

FIG. 7 shows barbecue skewers.

### DETAILED DESCRIPTION OF THE PREFERRED EMBODIMENTS

FIG. 1 shows a spatula member 1 according to the invention. The spatula member 1 has a handle 2 and a spatula 3, which is a tool for handling food products, for example a steak on a barbecue grill. The handle 2 may have a hole 4 for easy storage on a hook (not shown).

The spatula may be equipped with a hole 5 and additional holes 5′ such that liquid from the food product can flow from the spatula 3. Also, the holes 5, 5′ in the spatula provide an increased grip to the food product as compared to spatulas without holes. For marketing reasons, the holes 5, 5′ in the spatula 3 may be formed as a logo or name, for example of the producer or seller.

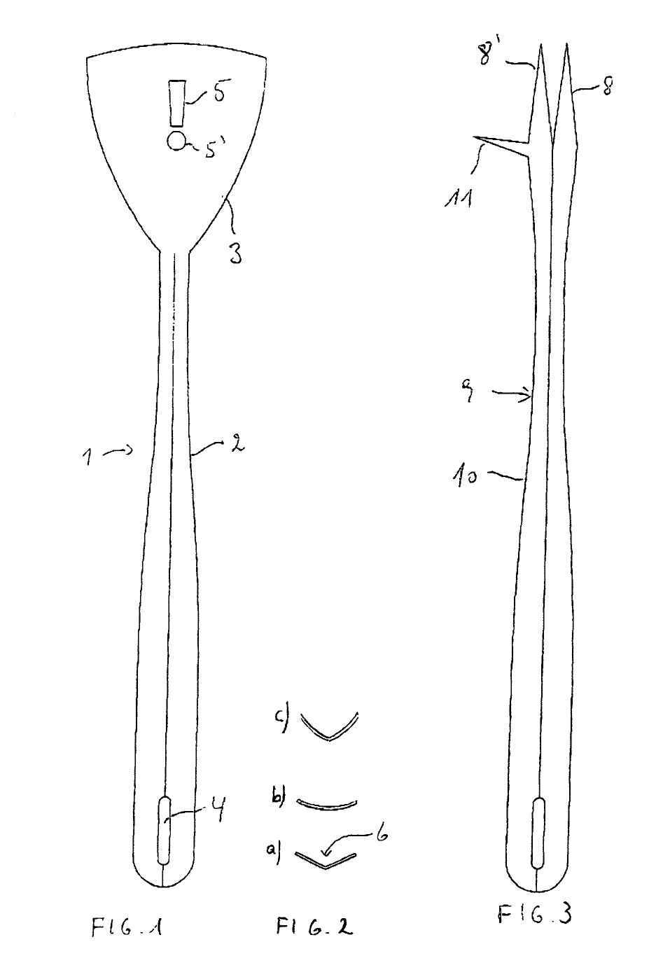

The handle 2 has a cross section, which is V-shaped as illustrated in FIG. 2a. The form of the handle ensures high stability and durability of the handle, also when used with relatively heavy food products, for example a large steak on the grill. Furthermore, the V-shape is comfortable to hold for the user. Also, the V-shape of the handle facilitates the placement of the kitchen utensil on a hook.

Additionally, the groove 6 in the handle 2 results in an ergonomically correct handling of the tool, where the thumb is placed inside the groove 6 and the handle 2 constitutes a natural extension of the user's arm without the necessity of a bend in the wrist. This way, even heavy food products can be lifted without requiring substantial strength in the wrist and arm of the user, which is an advantage especially for weak or elderly people.

Alternatively the cross section of the handle may be U-shaped as shown in FIG. 2b or V-shape with bending parts as shown in FIG. 2c. The advantages of the V-shape handle apply equally to the handles with these other two cross sectional shapes.

The spatula member 1 can be produced with a handle 2 and a spatula made by the same material, for example polymer or stainless steel, ensuring high stability and durability of the material. A spatula member formed in stainless steel as one single plate with a V-shaped or U-shaped handle has the advantage that it is easy to clean after use, because the spatula member has no joints where dirt may accumulate. Also such a spatula member, despite its simple appearance, has a very positive aesthetic appearance.

Preferably but not necessarily, the spatula may have sharp corners 7 in order to slide easily under the barbecue food on the grill. In this case, stainless steel as a material is preferred to ensure durability of the sharp corners 7.

In FIG. 3, a fork member 9 with two legs 8, 8′ is shown. The cross section of the handle 10 of the fork member 9 is formed into a V-shape or U-shape as the handle 2 of the spatula member 1 and exhibits the same advantages. However, for the fork member 9, the V-shape or U-shape of the handle 10 extends to the fork, which is V-shaped or U-shaped as well.

As a further advantageous, the fork member 9 is equipped with a hook 11 for lifting and turning food products as meat chunks on the grill. Especially on grills with a large number of food products, this tool is advantageous, as the lifting and flipping of products is performed much faster and easier than with other conventional tools as spatulas.

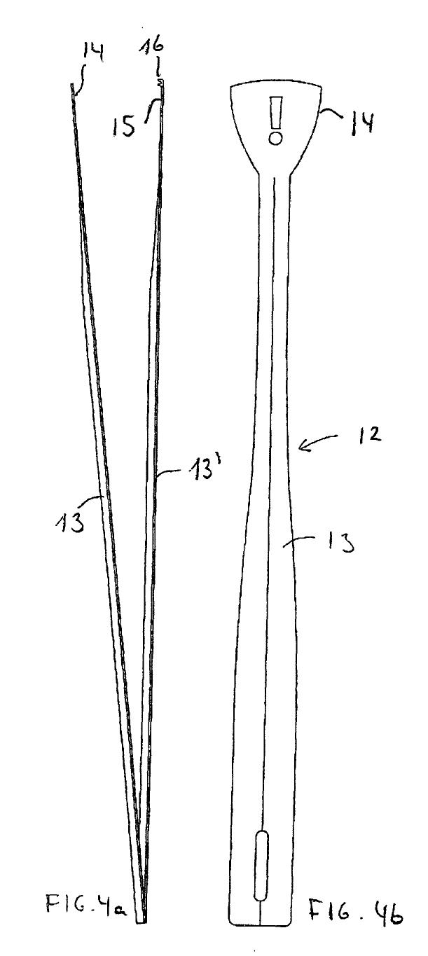

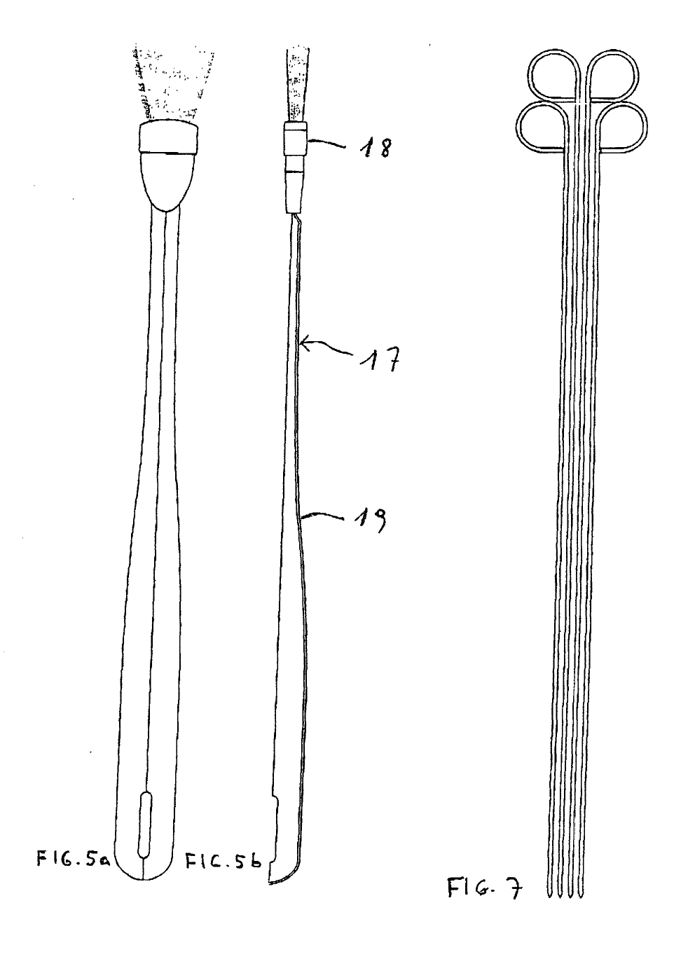

In FIGS. 4a and 4b, where FIG. 4a shown a side view, a tong member 12 is shown, where the advantageous V-shaped or U-shape for the handle 13 is used as well. The tong member consists of two handles 13, 13′ elastically pivoting at the end 14 of the handles 13, 13′. One distal end comprises a flat spatula 14 and the other distal end comprises a spatula 15 with teeth 16. The flat spatula 14 ensures an easy gliding under the food, while the teeth 16 of the opposite spatula 15 during grasping provides a secure grip of the food.

As with the previously described tool members, also the tong member can be produced as one piece. It has a bend at that distal end of the handle which is opposite to the tools 14, 15. The bend is V-shaped as well and provides a counteracting, spring-like effect when the two tools 14, 15 are pressed together.

Though a construction is preferred where the kitchen utensil according to the invention constitutes a single piece of sheet-material, a handle as described above can be combined with other tools, as for example a brush 18, which is shown in Figures 5a and 5b in two different views. The handle 19 of the brush member 17 may be constructed such as to be easily connected to the brush 18 during production. As the lifetime of a brush may be shorter than that of the handle 19, the invention has foreseen that a worn brush 18 may be demounted from the handle 19 and a new brush 18 mounted on the handle 19 by the user in an easy way.

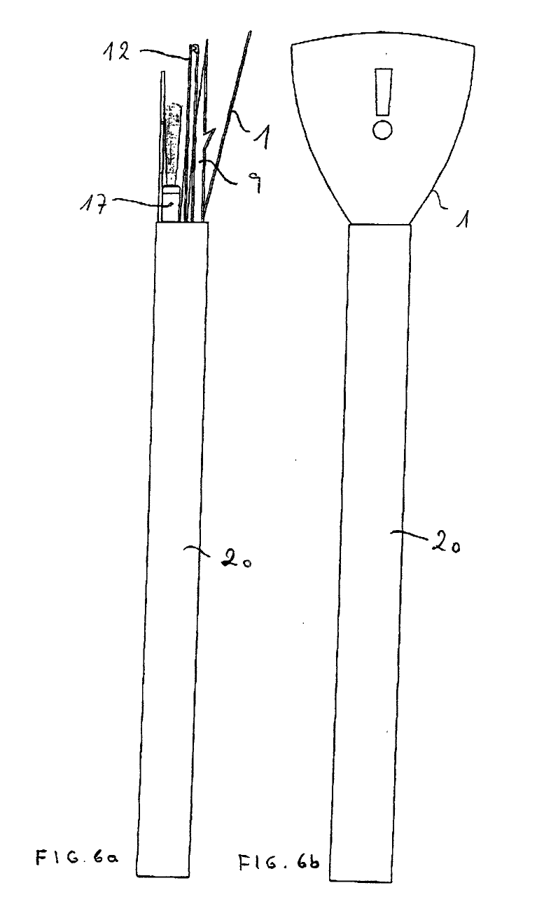

Because the handles 2, 10, 13, 13′, 19 of the tools 3, 8, 8′, 11, 14, 16, 18 are substantially plate like, a number of kitchen utensils of this type can be arranged with their handles in stacking conditions so as to form a compact unity, which is shown on FIG. 6a, and FIG. 6b, where FIG. 6a is a side view. The kitchen utensils, a spatula member 1, a fork member 9, a tong member 12, a brush member 17 and additionally skewers, which are shown in detail in FIG. 6, are easily stacked into a compartment 20 to form a compact unit for easy storage and transport conditions of this kitchen utensil kit.

Though the invention has been explained mainly in connection with a barbecue, it is obvious that the kitchen utensils according to the invention can be used for any other kind of food preparation.

We claim:

1. Kitchen utensil with a handle and a tool for handling food products, wherein the handle has a cross section which is substantially V-shaped or U-shaped.

2. Kitchen utensil according to claim 1, wherein the tool is at least one from the group consisting of a tong, a spatula, a fork, a hook, and a brush.

3. Kitchen utensil according to claim 1, wherein the tool is at least one from the group consisting of a tong, a spatula, a fork, and a hook, wherein the handle and the tool is made of the same material.

4. Kitchen utensil according to claim 3, wherein the kitchen utensil is on e single piece of plate-like material.

5. Kitchen utensil according to claim 3, wherein the material is a polymer or stainless steel.

6. Kitchen utensil according to claim 1, wherein at least part of the surface of said utensil is covered by a coating.

7. Kitchen utensil according to claim 6, wherein said coating has a rubber-like appearance.

8. Kitchen utensil according to claim 6, wherein said coating is heat resistant.

9. A kitchen utensil kit comprising at least two kitchen utensils according to claim 1 arranged with their handles in stacking conditions so as to form a compact unity of the kitchen utensil set.

10. Use of a kitchen utensil according to claim 1 for barbecue.
